(19) United States
(12) Patent Application Publication
(10) Pub. No.: US 2010/0096520 A1
(43) Pub. Date: Apr. 22, 2010

(54) SHOPPING CART RESTRAINT DEVICE

(76) Inventors: Kevin HOULIHAN, Citrus Heights, CA (US); Dyanne Rae Houlihan, Citrus Heights, CA (US)

Correspondence Address: GROSS & ASSOCIATES, 1415 L STREET SUITE 1000, SACRAMETO, CA, 95814, US

(21) Appl. No.: 12/254,751

(22) Filed: Oct. 20, 2008

(51) Int. Cl. F16B 47/00; B62D 39/00

(52) U.S. Cl. 248/206.2; 280/33.992

(57) ABSTRACT

A device for restraining a shopping cart to a vehicle comprising a first member having a suction portion and an opposing stem portion, wherein when the device is in use the first member is operably configured to be removably attached to the vehicle. The device further includes a second member having a first and second ends and having a hollow core extending from the first end to the second end, wherein the second end is attached to the stem portion of the first member, and a third member, wherein the third member is a length of cord having a first and second end. A fourth member is operably configured to be removably engaged with the shopping cart, when the device is in use, and wherein the first or second end of the third member is attached to the second member and the other end is attached to the fourth member.

### CROSS REFERENCE TO RELATED APPLICATION

This nonprovisional application claims the benefit of Provisional Application No. 60/999,644,521, filed on Oct. 19, 2007, which is incorporated herein by reference in its entirety and to which priority is claimed.

### BACKGROUND OF THE INVENTION

1. Field of Invention

The present invention relates generally to the preventing of a shopping cart from rolling away while a user is trying to unload the shopping cart.

2. Description of Related Art

Many consumers have faced the battle of trying to prevent a shopping or grocery cart from rolling away while trying to unload it, this is particularly important if a child is still in the grocery cart seat. Sometimes it is also difficult to keep the shopping cart from banging into the consumer's car or other cars in a parking lot.

Many attempts have been made to fix this problem. However, most conventional devices used to keep a shopping cart from rolling away involve the use of wheel brakes, which are often cumbersome to use. Further, these conventional devices are not installed on all carts and the user often times has no means of using them personally to restrain the cart. Moreover, conventional devices are cost prohibitive for a manufacturer to install. Still further, conventional devices are even more cost prohibitive for a store owner to retrofit the current inventory of shopping carts. Additionally, if the store owner desired to retrofit the current inventory of shopping carts, the retrofit process would take the shopping carts being modified out of service, which is not a desirable action.

Accordingly, it appears there exists a need to keep shopping/grocery carts from rolling away or banging into other objects, such as cars, and to meet this need without presenting manufacturers and store owners with an unreasonable expense or burden.

### SUMMARY OF INVENTION

It is the object of the present invention to overcome the drawbacks and shortcomings of conventional devices in use for keeping shopping carts from rolling away. This present invention allows for a user of shopping carts to attached the present invention to a shopping cart and keep the shopping cart from rolling away or colliding with other objects.

Further, the present invention allows for a conscientious store owner to retrofit a current inventory of shopping carts with the present invention at a reasonable cost and with no loss of service time for the shopping carts.

The present invention provides a device for restraining a shopping cart to a vehicle comprising: a first member having a suction portion and an opposing stem portion, wherein when the device is in use the first member is operably configured to be removably attached to the vehicle; a second member having a first and second ends and having a hollow core extending from the first end to the second end, wherein the second end is attached to the stem portion of the first member; a third member, wherein the third member is a length of cord having a first and second end; and, a fourth member operably configured to be removably engaged with the shopping cart, when the device is in use, wherein at least one of the first and second ends of the third member is attached to the second member and the other of the first and second ends is attached to the fourth member.

Still further, the present invention provides a device for restraining a shopping cart, comprising: a suction cup, having a release tab; a handle affixed to the suction cup; a cord having a first and second end; and, a connector being operably configured to be removably attachable to the shopping cart, wherein the first end of the cord is attached to the handle and the second end of the cord is attached to the connector.

Additionally, the present invention provides a restraining device to keep a shopping cart from rolling away from a vehicle while a user is unloading the shopping cart, comprising: a suction cup member having an attachment portion, a release tab and a stem portion having an orifice, wherein the attachment portion is operably configured to be removably attached to the vehicle; a handle member having a first and second portion and a hollow core which extends through the first and second portions, wherein the first portion has first and second ends, with the first end having a diameter less than the second end, further wherein the second portion has a first and second end with the first end disposed at the second end of the first portion and is cylindrical and having a diameter less than the second end of the first portion, and wherein the second end of the second portion includes a cavity and is attached to the suction cup within the orifice of the stem; an elastic cord member having a first and second end defining a length, wherein the first end of the elastic cord member extends through the core of the handle member from the first end of the first portion to the second end of the second portion and has a knot tied in the first end of the elastic cord, wherein the knot is disposed within the cavity of the second portion of the handle member; a latch attached to the elastic cord member and operably configured to be removably attach to the shopping cart, when the device is in use.

This invention overcomes the drawbacks and shortcomings of the prior art conventional devices and systems. These and other features and advantages of this invention are described in, or are apparent from, the following detailed description of various exemplary embodiments of the devices and methods according to this invention.

### BRIEF DESCRIPTION OF THE DRAWINGS

Various exemplary embodiment of this invention will be described in detail, with reference to the following figures, wherein;

FIG. 1 is a perspective view of a device made in accordance with the present invention;

FIG. 2 is an exploded perspective rear view of the device in FIG. 1;

FIG. 3 is a perspective view of the device in FIG. 1 when in use;

FIG. 4 is a top view of a first member of the device in FIG. 1;

FIG. 5 is a side view of the first member of FIG. 4;

FIG. 6 is a side view of a second member of the device in FIG. 1;

FIG. 7 is a cross-sectional view of the second member taken along line 7-7 of FIG. 6;

FIG. 8 is a right end view of the second member of FIG. 6;

FIG. 9 is a side view of a third member of the device in FIG. 1;

FIG. 10 is a top view of a third member of FIG. 9;

FIG. 11 is a cross-sectional view of the third member taken along line 11-11 of FIG. 9;

FIG. 12 is a perspective view of an alternative embodiment of the device made in accordance with the present invention;

FIG. 13 is a side view of an alternative embodiment of a connector member, made in accordance with the present invention;

FIG. 14 is a top view of the connector member of FIG. 13; and,

FIG. 15 is a bottom view of the connector member of FIG. 13.

### DETAILED DESCRIPTION

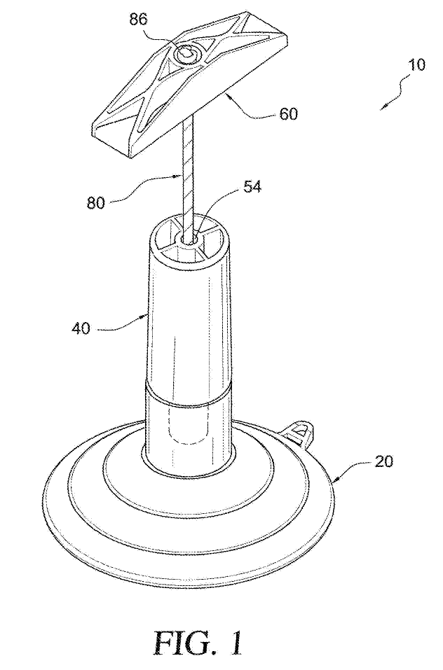

FIG. 1 is a perspective view of a device 10, made in accordance with the invention. The device 10 prevents a conventional shopping or grocery cart from rolling away or banging into a car while a user or consumer unloads the shopping cart. Preventing a shopping cart from rolling away is beneficial to prevent damage to other vehicles and is particularly important to parents who have toddler or infants in a seat of the shopping cart. In the present embodiment, the device 10 is removably attached to the car and the shopping cart.

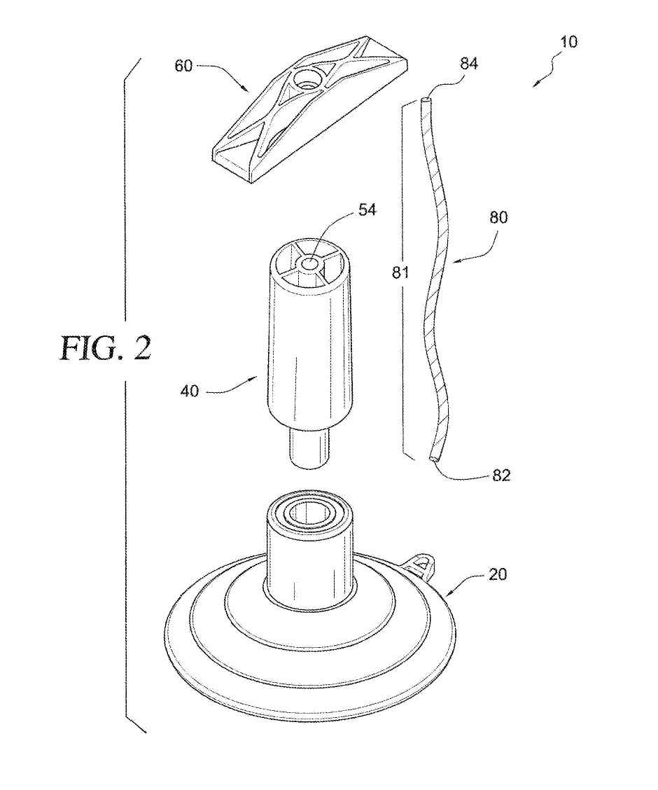

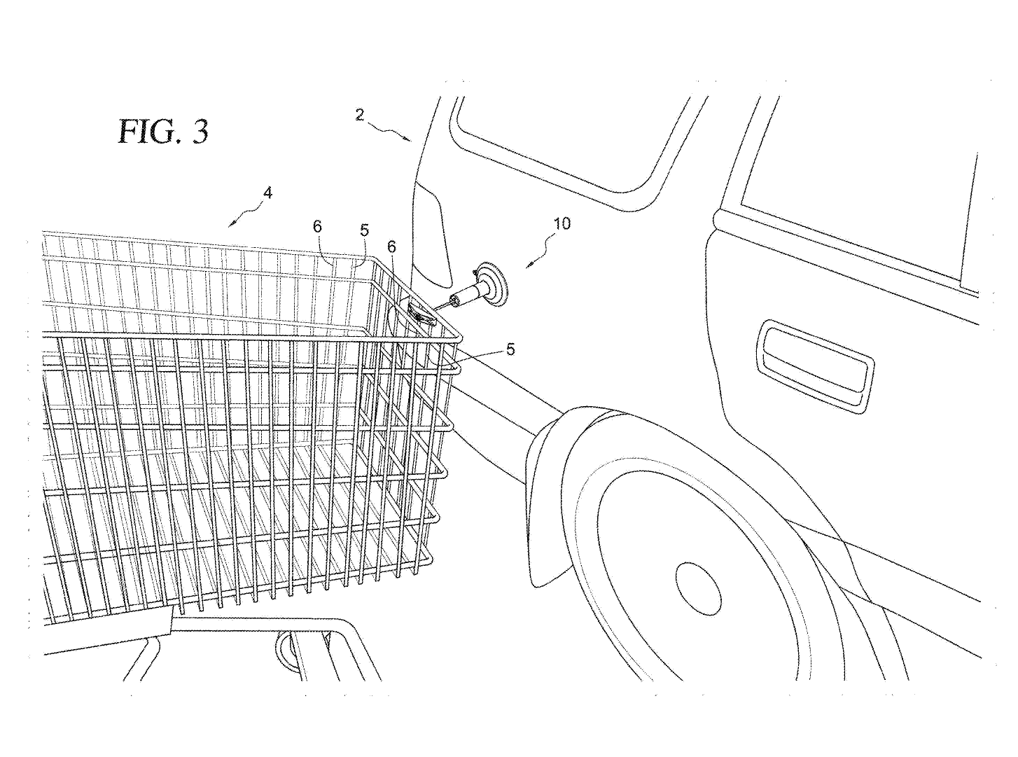

The device 10 includes a first member 20, a second member 40, a third member 80 and a fourth member 60 as shown in FIG. 2. The user removably attaches the first member 20 onto a smooth surface, in this case a vehicle or car 2 and the user removably attaches the third member to the shopping cart 4 as shown in FIG. 3. For better ability to keep the shopping cart from moving, especially if the shopping cart has caster wheels, it is best to attach the third member to an end of the shopping cart that has caster or pivoting wheels.

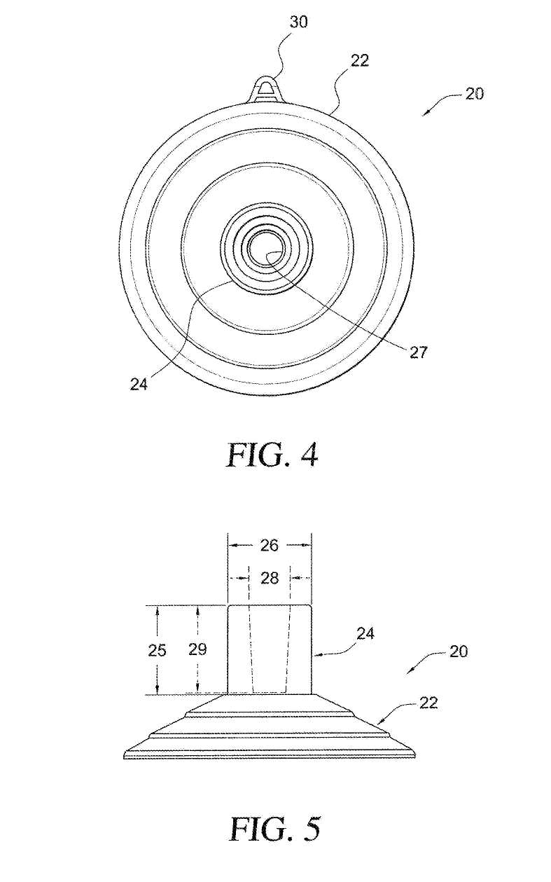

The first member 20, as shown in FIGS. 4 and 5 is a suction cup. The first member 20 may be any know or conventional type suction cup provided it can attach to the second member 40. The suction cup 20 in this exemplary embodiment includes a base portion 22, a stem portion 24 and a release tab 30. The base portion or attachment portion 22 is circular having a diameter 23. The stem portion 24 has a height 25, a diameter 26 and an orifice 27 having a diameter 28 and a depth 29. The release 30 is a tab disposed along the circumference of the base portion 22. The tab 30 provides the user an easy method of releasing the suction from the suction cup 20. It is preferred that the suction cup be operably configured to be securable to a clean surface of a vehicle. The suction cup preferably provides at least about 20 lbs of adhesion force to the vehicle surface. It is further preferred that the suction cup provide a breaking or adhesion strength in a range between about 20 lbs and 60 lbs. The suction cup 20 is preferably a suction cup that are conventionally available, such as those manufactured by Adams Manufacturing, Corp of Porterville, Pa.

In the present embodiment, the diameter 23 of the base portion is 82.55 cm, the height 25 of the stem portion is 25.40 cm, the diameter 26 of the stem portion is 23.75 cm, the depth 29 of the orifice is 25.00 cm and the diameter 28 of the orifice is 11.05 cm. It should be appreciated that in other various exemplary embodiments, the values of the dimensions may vary depending upon desired size of the device 10.

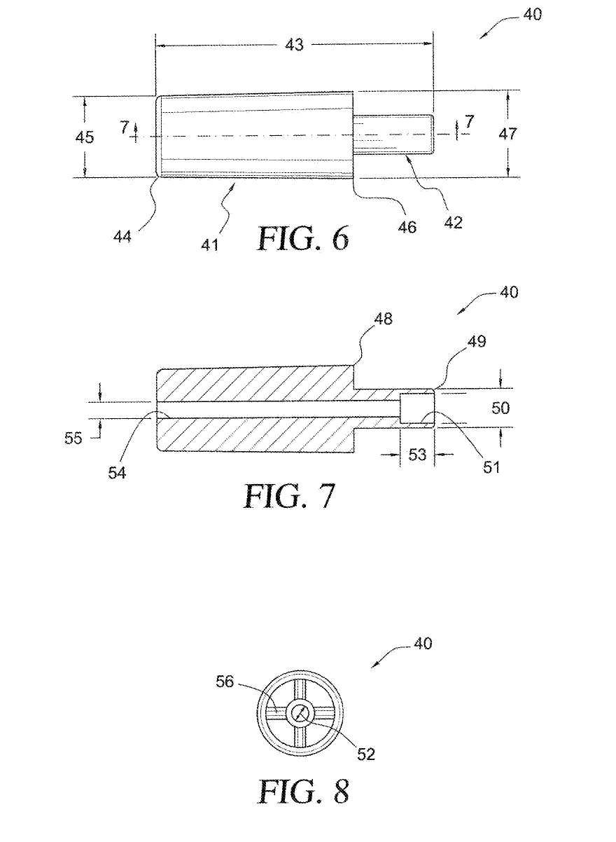

FIGS. 6 through 8 show the second member 40. The second member 40 is a spacer or handle. The second member 40 includes a first portion 41 and a second portion 42 disposed along a length 43. The first and second portions 41 and 42 combine to define the length 43. In other alternative exemplary embodiments, more or less portions are utilized.

The first portion 41 has a first end 44 having a diameter 45 and a second end 46 having a diameter 47. In the present embodiment, the first portion has a generally tapered cylindrical shape. It is preferred that the first end diameter 45 be smaller than the second end diameter 47. It should he appreciated that in other various exemplary embodiments, other shapes may be used, for example; octagonal, square or triangular.

In the present embodiment, the first portion 41 has a length of 2.0 cm and the second portion 42 has a length of 0.90 cm equaling the length 43 of the second member 40. The diameter 45 of the first end 44 is 0.186 cm and the diameter 47 of the second end 46 is 0.95 cm. Further, the first end 44 includes a radius of 0.60 cm to round the edge off. It should be appreciated the in other various exemplary embodiments, the values of the dimensions could change depending on the size desired for the device 10. The overall length of the second member may in other exemplary embodiments be shorter in length than in the embodiment described above, ranging from about 0.6 cm to about 1.3 cm.

The second portion 42 of the spacer 40 has a first end 48 and a second end 49. The first end 48 is disposed against the second end 46 of the first portion. In the present embodiment, the first and second portions are integral. However, it should be appreciated that in other various embodiments, the first and second portions of the second member are not integral. The second portion 42 is cylindrical in shape having a diameter 50.

Disposed within the second end 49 of the second portion 42 is a cavity 51. The cavity 51 has a diameter 52 and a depth 53. In the present embodiment, the diameter 50 of the second portion 42 is 0.425 cm. The diameter 52 of the cavity 51 is about 0.324 cm and the depth 53 is about 0.400 cm. Once again, it should be appreciated that in other various exemplary embodiments, the dimensional values presented may be changed depending on the desired size for the device 10.

The second member 40 is preferably hollow having a bore or hollow core 54 extending through the entire length 43. The hollow core 54 is preferably axially aligned with the longitudinal axis of the second member. In the present embodiment the core has a diameter 55 of 0.186 cm; however, it should be appreciated that in other various exemplary embodiments, the core diameter is other values depending on the diameter of the third member 80. The diameter of the core needs to be greater than the diameter of the third member 80.

The handle 40 in the present embodiment is molded out of acrylonitrile butadiene styrene (ABS) hardened plastic. The first portion 41 includes a plurality of vanes 56 to reduce weight and save on material as is common in the art of plastic molding. It should be appreciated that the second member 40 could be solid and made out of other materials, such as wood for example.

The second portion 42 of the handle 40 is operably configured to be disposed within the orifice 27 of the first member 20. The handle 40 is affixed to the suction cup 20 by conventional adhesives common in the art, such as, but not limited to acrylic adhesives that contain a flexible element. In some exemplary embodiments, an adhesive sold under the trademark Devcon Plastic Welder (part #14320) and made by ITW Devcon of Danvers, Mass. is utilized. Prior to attaching the second member 40 to the first member 20, the third member 80 is partially disposed within the core 54 of the second member 40, as will be discussed further below. It should be appreciated that other means of attaching the second portion to the first portion are utilized in other embodiments, such as but not limited to a locking pin, clamps, fasteners and the like.

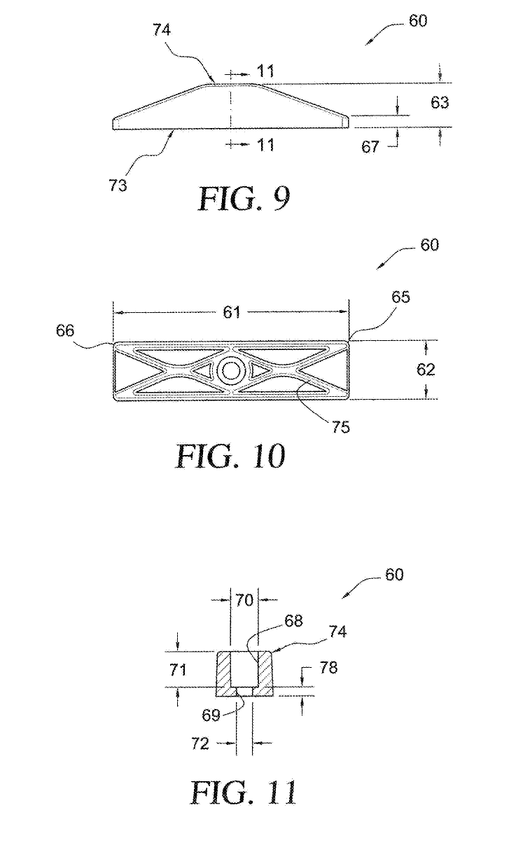

Referring now to FIGS. 9 through 11, shown is the fourth member 60. The fourth member may also be referred to herein as a plate, connector, connector member or a latch 60. The plate or connector 60 has length 61, a width 62 and a height 63. The length 61 is defined between a first end 65 and a second end 66. The first and second ends 65 and 66 have a height 67. The connector 60 also includes a first surface 73 and a second surface 74.

The fourth member 60 further includes a first orifice 68 and a second orifice 69. The first orifice 68 starts on the second surface 74 at a point that is at the intersection of the midpoint of the length 61 and the width 62. The first orifice 68 has diameter 70 and a length 71. The second orifice 69 has a diameter 72 and a length 78, which is equal to the height 67 of the first and second ends 65 and 66. The combined lengths 71 and 78 equal the height 63 of the fourth member 60. The first and second orifices 68 and 69 are preferably coaxially aligned.

The fourth member 60 is preferably shaped and sized so that the width 62 may easily fit or slide between a gap defined by two adjacent bars or components 5 and 6 (FIG. 3) of a shopping cart 2. Further, it is preferred that the fourth member 60 be shaped and sized so that the length 61 of the fourth member 60 may not fit or slide between two adjacent bars 5 and 6 (FIG. 3). The length 61 of the fourth member is preferably greater in dimension than the gap defined by the components of the shopping cart and the width 62 of the fourth member is less than the gap. It is preferred that the length 61 of the fourth member be no less than 112% times the size of the gap or hole in the cart that it is going to operably engage. It is further preferred that the length 61 of the fourth member be between 112% and 200% times the size of the gap or hole in the cart that it is going to operably engage. Having the size and shape relationships as disclosed herein provides for the fourth member to properly engage and remain engaged to the shopping cart without disengaging from the cart until the user selectively desires to rotate the fourth member and let it slip back through the gap or hole of the shopping cart. Additionally, it is preferred that the length 61 of the fourth member be at least about 2.6 inches. It is still further preferred that the length 61 be between about 2.6 inches and about 3.0 inches. In the present exemplary embodiment, the length 61 is about 2.634 cm and the width 62 is about 0.634 cm. The height 63 of the connector 60 is about 0.500 cm. The height 67 of the first and second ends 65 and 66 is about 0.100 cm. The diameter 70 of the first orifice 68 is about 0.310 cm and the depth 71 is about 0.400 cm. The diameter 72 of the second orifice 69 is about 0.185 cm. It should be appreciated that in other various exemplary embodiments, the dimensional value presented may be changed depending on the size desired for the device 10.

The fourth member or plate 60 in the present embodiment is molded out of acrylonitrile butadiene styrene (ABS) hardened plastic similar to the handle 40. The plate 60 is not solid, like the handle 40, the plate 60 includes a plurality of vanes 75 to reduce weight and material required in manufacturing, as is common in the art of molded plastics. It should be appreciated that the third member could be constructed out of other materials such as wood or metal, for example.

The third member or cord 80 has a length 81 defined by a first end 82 and a second end 84, as shown in FIG. 2. The length 81 is preferably greater in dimension than the length 43 of the second member 40 plus the height 63 of the fourth member 60. To assemble the device, a retention device, not shown, is disposed in the first end of the cord. The second end is inserted into the core 54 of the second member 40 and the cord is pulled through the bore 54 so that the retention means is disposed within the cavity 51 of the second member 40. The second end of the cord 80 is inserted through the second orifice 69 and first orifice 68 of the fourth member 60. A second retention device 86 is disposed on the second end of the cord 80 and the second knot 86 is configured to be operably disposed in the first orifice 68 of the fourth member 60. The device 10 is assembled once in this configuration. In this exemplary embodiment the retention devices discussed above are knots formed by tying the cord to itself. It is further preferred that the knots be figure eight style knots. It should be appreciated that in other exemplary embodiments, other retention devices are utilized, such as but not limited to clamps, washers, etc. and the like. The third member 80 is also a tether.

The cord 80 in the present embodiment is preferably elastic. The third member or tether 80 is preferably one eighth inch elastic polyester cord. It should be appreciated that the cord 80 could be other materials common in the use of ropes and cords, such as nylon, for example. The cord is preferred to be about 5/32 inch thick. It is further preferred that the cord have a minimum breaking strength of about 60 pounds. Additionally, it is preferred that the cord strength exceed the suction cup or first member adhesion strength by at least 100%.

As an example of the operation of the device 10, a user would be shopping with a conventional shopping or grocery cart 4, which is of a wire basket construction, as shown in FIG. 3. When the user takes the shopping cart 4 to the user's vehicle 2, the user prior to unloading the shopping cart 4, places the plate 60 through the spacing between the bars of the wire basket on the shopping cart 4. The user then presses the suction cup 20 against a side of the vehicle 2. The shopping cart 4 is now attached to the vehicle and will not roll away or roll into the vehicle. For better stability of the shopping cart, it is preferred to attach the plate 60 to the end of the shopping cart that has caster wheels, if the cart is of the type that has caster wheels. The fourth member, or latch, will not slip out from the cart regardless of the hole used or if the cord becomes slack due to the ideal length and width of the latch. This applies to wire construction type carts that have horizontal and vertical bars as shown in FIG. 3, as well as carts that have a plastic hexagonal type arrangement of the bars that make-up the cart. For conventional wire type carts as shown in FIG. 3, it is preferred for the latch to be utilized in the top narrow row of bars to ensure effectiveness of the latch rest.

The device 10 can be sold by the store owner thus creating a revenue stream and providing consumers with the ability to keep shopping carts from rolling away. Users can carry the device 10 to have available and ready for use.

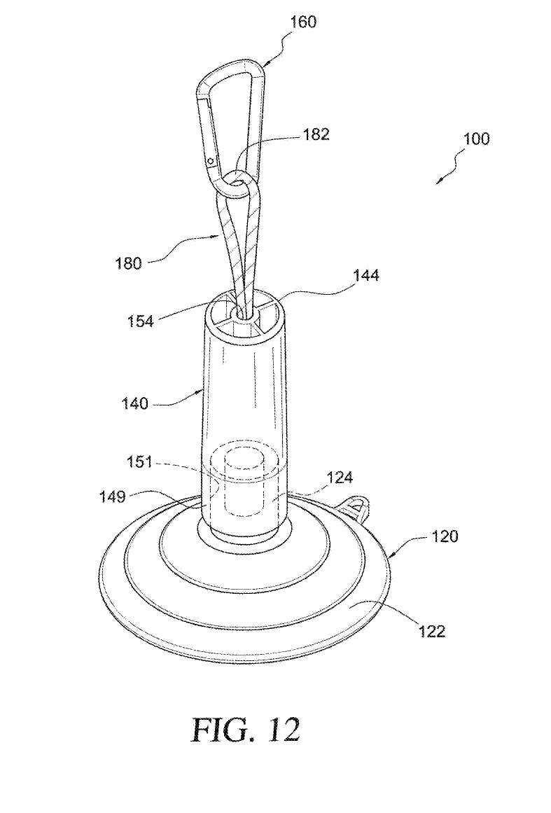

Referring now to FIG. 12 a device 100 is shown. The device 100 is an alternative embodiment made in accordance with the present invention. The device 100 is similar to the device 10 described above. The device 100 includes a first member 120, a second member 140, a third member 160 and a fourth member 180.

The first member or suction cup 120 is the same as the suction cup 20 in the device 10. The suction cup has a base portion 122 and a stem portion 124. The second member or handle 140 is different from the second member described in the device 10 in that the second member 140 is one portion having a hollow cylindrical shape. The second member 140 has a first end 144 and a second end 149. The second member 140 includes a bore or hollow core 154, which extends from the first end 144 through to the second end 149. In this embodiment the second end includes a cavity 151 that has a diameter that is large enough to receive the stem 124. The stem 124 is affixed to the interior of the cavity at the second end 149 of the second member. The cavity 151 is also operably configured to receive both ends of the third member 180 as will be discussed further below.

The third member or cord 180, is similar to the cord 80 in the device 10, in that the cord 180 has a length defined by a first end and a second end. Prior to placing the second end 149 over the stem portion 124, both the first end and the second end of the cord 180 are inserted into the first end 144 through to the second end 149. The first and second ends of the cord 180 are tied in a figure-of-eight loop knot (or affixed together through some other conventional means), such that a loop 182 is formed exterior to the first end 144 of the handle 140. The loop 182 is pulled such that the knot is wedged tight inside the cavity 151 of the handle 140.

The fourth member or connector 160 is different from the fourth member 60 of the device 10. In this embodiment, the connector 160 is a conventional carabineer clipped onto the loop 182 of the cord 180.

The device 100 is used in the same way as the device 10 is used. The user 2 presses the suction cup 120 onto a side of the vehicle and then hook the carabiner 160 to a bar 5 of the shopping cart 4.

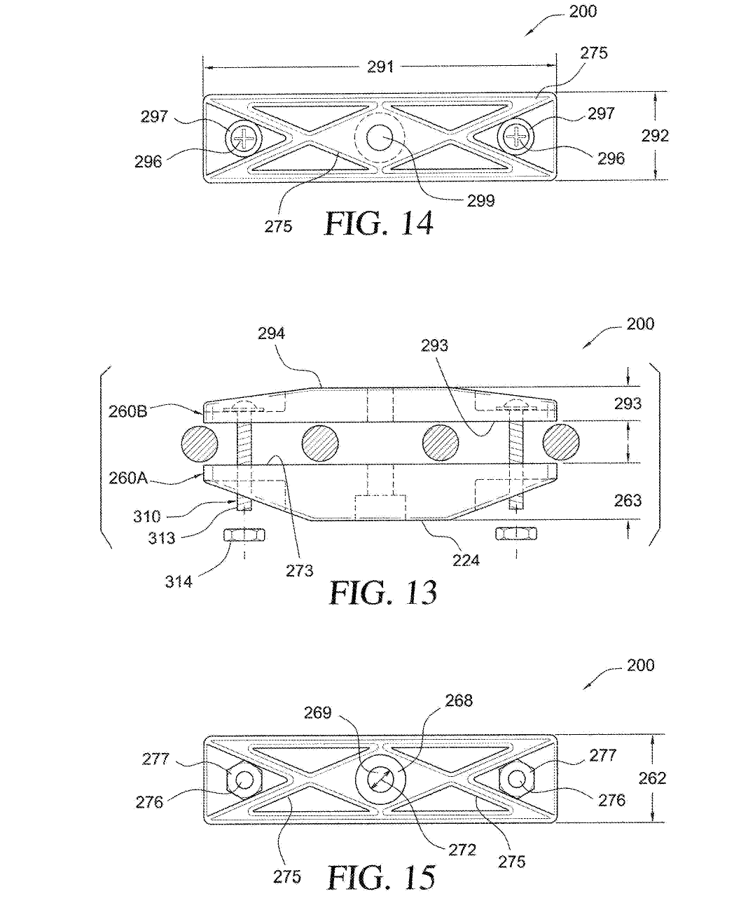

FIGS. 13 through 15, illustrate an alternative exemplary embodiment of a fourth member or connector 200, made in accordance with the present invention. The fourth member 200 is similar to the fourth member 60 discussed above in connection with the device 10. The fourth member 200 can be used as a replacement for the device 60 and can be utilized with the remaining components of the device 10. The first portion 200 has a length 291, a width 262 and a height 263.

The fourth member 200 further includes a first orifice 268 and a second orifice 269. The first orifice 268 starts on the second surface at a point that is at the intersection of the midpoint of the length 291 and the width 262. The first orifice 268 has diameter and a depth. The second orifice 269 has a diameter and a height.

In the present embodiment, the length 291 is 2.634 cm and the width 262 is 0.634 cm. The height 263 of the first member 60 is 0.500 cm. The diameter 270 of the first orifice 268 is 0.310 cm and the depth 271 is 0.400 cm. The diameter 272 of the second orifice 269 is about 0.185 cm. It should be appreciated that in other various exemplary embodiments, the dimensional value presented may be changed depending on the size desired for the device 10.

The fourth member 200 is different from the fourth member 60, in that the fourth member 200 includes a first portion 260A and a second portion 260B, and a plurality of fasteners 310. Further, the first portion 260A includes two additional orifices, orifices 276 and cavities 277. The cavity 277 in the present embodiment is six sided to allow the fit of a fastener, such as a six sided nut. It should be appreciated that in other various exemplary embodiments other fasteners common in the art may be used and the cavity operably configured to receive the fastener chosen. The orifices 276 are the same as the orifice 269, however, the orifices 276 allow for the fastener 310 to pass through the first portion 260A.

The first of the orifices 276 and cavities 277 is disposed on one side of the cavity 268 halfway between the cavity 268 and the first end 265. The second of the orifices 276 and cavities 277 is disposed halfway between the cavity 268 and the second end 266.

The second portion 260B has a length and a width 291 and 292, which are equal to the length and width of the first portion 260A. The second portion 260B has a height 263, a first surface 293 and a second surface 294. The second portion 290 further includes a plurality of orifices. The first orifice 299 corresponds to the orifice 269 of the first portion. The orifice 299 allows for the cord 80 to pass through. Two more orifices 296 are disposed on the second portion opposite the two orifices 276 of the first portion 260. The two orifices 296 allow for the plurality of fasteners 310 to pass through the second portion 290.

The second portion 260B further includes two cavities 297, similar to the cavities 277 on the first portion 260A. The cavities 297 in the present embodiment are circular and operably configured to receive a head of the fastener 310. Further, the fastener 310 used in the present embodiment is a bolt and nut fastener common in the art. It should be appreciated that in other various exemplary embodiments, other fasteners common in the art may be used.

The first portion 260A and second portion 260B in the present embodiment is molded out of acrylonitrile butadiene styrene (ABS) hardened plastic similar to the handle 40. The first portion 260A and second portion 260B are not solid, and the portions include a plurality of vanes 275 to reduce weight and material required in manufacturing, as is common in the art of molded plastics. It should be appreciated that the first and second portions could be constructed out of other materials such as wood or metal, for example.

When the fourth member or connecter 200 is in use, the first and second portions 260A and 260B are affixed to the shopping cart with the plurality of fasteners 310. The device 10 is not removable by the consumer. The device 10 with the fourth member 200 provides a way for the store owner to modify an existing inventory of shopping carts without great expense and without taking the shopping carts out of service.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A device for restraining a shopping cart to a vehicle comprising:
a first member having a suction portion and an opposing stem portion, wherein when the device is in use the first member is operably configured to be removably attached to the vehicle;
a second member having a first and second ends and having a hollow core extending from the first end to the second end, wherein the second end is attached to the stem portion of the first member;
a third member, wherein the third member is a length of cord having a first and second end; and,
a fourth member operably configured to be removably engaged with the shopping cart, when the device is in use,
wherein at least one of the first and second ends of the third member is attached to the second member and the other of the first and second ends is attached to the fourth member.

2. The device, as recited in claim 1, wherein fourth member has a length, a first surface and a second surface, wherein an orifice penetrates the fourth member from the first surface to the second surface and the second end of the cord is attached to the fourth member through the orifice.

3. The device, as recited in claim 1, wherein the fourth member is a carabineer.

4. The device, as recited in claim 1, wherein the fourth member has a length and a width, wherein the length of the fourth member is greater than a gap defined by components of the shopping cart and wherein the width of the fourth member is less than the gap.

5. The device, as recited in claim 4, wherein the length of the fourth member is at least 2.6 inches.

6. The device, as recited in claim 1, wherein the first member includes a release tab.

7. The device, as recited in claim 1, wherein the third member is an elastic cord.

8. The device, as recited in claim 1, wherein the second member has a length, first end and a second end, wherein the second member is a tapered cylinder with the second end having a larger diameter than the first end and the second member is attached to the first member at the second end.

9. The device, as recited in claim 1, wherein the stem portion of the first member further includes an orifice and the second member further includes a first and second portion and a core which extends through the first and second portions, wherein the first portion has first and second ends, with the first end having diameter less than the second end, further wherein the second portion has a first and second end with the first end disposed at the second end of the first portion and is cylindrical and having a diameter less than the second end of the first portion, and wherein the second end of the second portion includes a cavity and is attached to the first member within the orifice of the stem portion.

10. The device, as recited in claim 9, wherein the third member is an elastic cord and wherein the first end of the elastic cord extends through the core of the second member from the first end of the first portion to the second end of the second portion and has a knot tied in the first end of the elastic cord, wherein the knot is disposed within the cavity of the second portion of the second member.

11. A device for restraining a shopping cart, comprising:
a suction cup, having a release tab;
a handle affixed to the suction cup;
a cord having a first and second end; and,
a connector being operably configured to be removably attachable to the shopping cart, wherein the first end of the cord is attached to the handle and the second end of the cord is attached to the connector.

12. The shopping cart restraining device, as recited in claim 11, wherein the connector has a length, a first surface and a second surface, wherein an orifice penetrates the connector from the first surface to the second surface and the second end of the cord is attached to the connector through the orifice.

13. The shopping cart restraining device, as recited in claim 11, wherein the connector is a carabineer.

14. The shopping cart restraining device, as recited in claim 11, wherein the connector has a length and a width, wherein the length of the connector is greater than a gap defined by components of the shopping cart and wherein the width of the connector is less than the gap.

15. The shopping cart restraining device, as recited in claim 11, wherein the cord is an elastic polyester cord.

16. The shopping cart restraining device, as recited in claim 11, wherein the suction cup further includes a stem having an orifice and the handle further includes a first and second portion, with the first portion having first and second ends, with the first end having diameter less than the second end, further wherein the second portion is disposed at the second end of the first portion and is cylindrical and having a diameter less than the second end and wherein the second portion is attached to the suction cup within the orifice of the stem.

17. A restraining device to keep a shopping cart from rolling away from a vehicle while a user is unloading the shopping cart, comprising:
a suction cup member having an attachment portion, a release tab and a stem portion having an orifice, wherein the attachment portion is operably configured to be removably attached to the vehicle;
a handle member having a first and second portion and a hollow core which extends through the first and second portions, wherein the first portion has first and second ends, with the first end having diameter less than the second end, further wherein the second portion has a first and second end with the first end disposed at the second end of the first portion and is cylindrical and having a diameter less than the second end of the first portion, and wherein the second end of the second portion includes a cavity and is attached to the suction cup within the orifice of the stem;
an elastic cord member having a first and second end defining a length, wherein the first end of the elastic cord member extends through the core of the handle member from the first end of the first portion to the second end of the second portion and has a knot tied in the first end of the elastic cord, wherein the knot is disposed within the cavity of the second portion of the handle member; and,
a latch attached to the elastic cord member and operably configured to be removably attached to the shopping cart, when in the device is in use.

18. The restraining device, as recited in claim 17, wherein the wherein the latch has a length and a width, wherein the length of the latch is greater than a gap defined by components of the shopping cart and wherein the width of the latch is less than the gap.

19. The restraining device, as recited in claim 17, wherein the connector member has a length, a first surface and a second surface, wherein an orifice penetrates the connector member from the first surface to the second surface and the second end of the cord member is attached to the connector member through the orifice.

20. The restraining device, as recited in claim 17, wherein the connector member is a carabineer.
